(19) United States
(12) Patent Application Publication
(10) Pub. No.: US 2014/0186725 A1
(43) Pub. Date: Jul. 3, 2014

(54) FUEL CELL SYSTEM AND METHOD OF PURGING THE SAME

(71) Applicant: Hyundai Motor Company, Seoul (KR)

(72) Inventors: Hyunjae Lee, Seoul (KR); Jong Hyun Lee, Yongin (KR); Deukkeun Ahn, Yongin (KR)

(73) Assignee: HYUNDAI MOTOR COMPANY, Seoul (KR)

(21) Appl. No.: 14/134,763

(22) Filed: Dec. 19, 2013

(30) Foreign Application Priority Data
Dec. 31, 2012 (KR) 10-2012-0158607

(51) Int. Cl. H01M 8/04

(52) U.S. Cl. CPC H01M 8/04231
USPC 429/410

(57) ABSTRACT

A fuel cell system and a method of purging the same are provided. The fuel cell system includes: a fuel cell stack that includes a fuel electrode and an air electrode as well as an air supply unit that supplies air of a blower to the air electrode via a humidifier through an air supply line. A water trap collects condensed water that is generated at the fuel electrode, and a drain valve that is installed within a drain line between the water trap and the humidifier is also provided. A purge valve is installed at a purge line that is branched from the drain line between the fuel cell stack and the water trap. in particular, by opening the drain valve and the purge valve during operation, condensed water and unreacted hydrogen are each exhausted to the humidifier, and when operation is terminated, by opening the drain valve, condensed water and unreacted hydrogen are exhausted to the humidifier, and by opening the purge valve in a different flow direction, unreacted hydrogen is purged to the air electrode inlet side.

### CROSS-REFERENCE TO RELATED APPLICATION

This application claims priority to and the benefit of Korean Patent Application No. 10-2012-0158607 filed in the Korean Intellectual Property Office on Dec. 31, 2012, the entire contents of which are incorporated herein by reference.

### BACKGROUND

(a) Field of the Invention

The present invention relates to a fuel cell system and a method of purging the same. More particularly, the present invention relates to a fuel cell system and a method of purging the same that recycle unreacted hydrogen of a fuel electrode that is dumped when operation is terminated as an internal filling gas of an air electrode.

(b) Description of the Related Art

In general, a fuel cell system typically includes a fuel cell stack that generates electrical energy for powering various devices, a fuel supply unit that supplies fuel such as hydrogen, an air supply unit that supplies air as an oxidant that is necessary for an electrochemical reaction within the fuel cell stack, a heat/water management unit that removes heat generated by a reaction within the fuel cell stack to outside of the system, that controls an operational temperature of the fuel cell stack, and that performs water management, and a controller that controls the entire operation of the fuel cell system.

Typically, the fuel supply unit includes a fuel tank, a high pressure/low pressure regulator, and a fuel recycling unit. The oxidant supply unit typically includes a blower and a humidifier, and the heat and water management unit typically includes a coolant pump and a radiator.

Typically, hydrogen is used as the source of fuel. When hydrogen is used, hydrogen under a substantially high pressure is supplied from the hydrogen tank of the fuel supply unit to the fuel cell stack which typically has a lower pressure via the high pressure/low pressure regulator. The fuel recycling unit by installing a recycling blower in a recycling line, continuously recycles any unreacted hydrogen that remains after being used within a fuel electrode of the fuel cell stack to the fuel electrode. This allows for the efficient reuse of the hydrogen.

In the air supply unit, dry air that is supplied by the blower is humidified by exchanging moisture with an exhaust gas (i.e., humid air) that is exhausted from an air electrode outlet of the fuel cell stack while passing through a humidifier and is supplied to an air electrode inlet of the fuel cell stack accordingly.

The stack of the fuel cell system is typically formed in an electricity generator set in which a plurality of unit cells are continuously arranged, and each unit cell is provided as a fuel cell of a particular unit that generates electrical energy by an electrochemical reaction of the fuel (e.g., hydrogen) and air.

Each unit cell includes a membrane-electrode assembly (MEA) and separators that are disposed in close contact with the MEA at both sides thereof. That is the separators are re conductive in nature and are typically shaped like a plate. The separator also includes channels, through which fuel and the oxidant flow along a surface in close contact with the membrane-electrode assembly, respectively.

The membrane-electrode assembly includes a fuel electrode (i.e., an anode) on one surface and forms an air electrode (i.e., cathode) on the other one surface. Additionally, an electrolyte membrane is disposed between the fuel electrode and the air electrode.

A fuel electrode separates fuel that is supplied through a channel within the separator into negatively charged electrons and positively charged protons through an oxidation reaction. The positively charged ions travel through the electrolyte to the cathode since the electrolyte membrane is specifically designed to allow only ions to pass therethrough. The negatively charged ions are then passed into an circuit to generate an electrical current.

Once the ions reach the air electrode water and a heat are generated through a reduction reaction positively charged ions that are received from the fuel electrode and electrons within oxygen that is being received through a channel of the separator.

A portion of water that is generated in the air electrode by a chemical reaction is moved to the fuel electrode because it permeats the electrolyte membrane. When this happens, water that reaches the fuel electrode remains in a catalyst layer. This reduces the effectiveness of the catalyst reaction, and when water t remains in a channel of the electrode, the supply path of the fuel may become blocked.

Therefore, as shown in FIG. 1, conventionally a water trap 120 that collects and exhausts water remaining in a catalyst layer or a channel and a purge line 140 that exhausts impurities (including an unreacted hydrogen gas) within the fuel electrode to a humidifier 130 may be further connected to the fuel electrode of a stack 110. A drain line 122 that exhausts water to the humidifier 130 may be connected to the water trap 120, and a drain valve 124 that exhausts water by opening every purge cycle may be provided in the drain line 122. Further, a purge valve 142 may be provided in the purge line 140 to exhaust impurities (including unreacted hydrogen) within the fuel electrode during every purge cycle.

A fuel cell vehicle to which such a fuel cell system can be applied is generally driven with a fuel cell system which has a high voltage (i.e. a couple hundred volts or more), and electrical components such as an inverter and a motor for driving the fuel cell vehicle use such this high voltage to operate.

However, such a fuel cell system may influence durability performance of the fuel cell stack during an open circuit voltage (DCV) upon starting/stopping and an DCV reduction speed. Further, when operation of the vehicle is terminated, external air may penetrate into the air electrode since the air electrode has more access to external air then the fuel electrode.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a fuel cell system and a method of purging the same which improves an DCV reduction speed by filling unreacted hydrogen that is exhausted by fuel electrode purge cycle at an air electrode, shortening an operation termination time, and indirectly improving fuel consumption.

An exemplary embodiment of the present invention provides a fuel cell system including: a stack that has a fuel electrode and an air electrode; an air supply unit that supplies air from a blower to the air electrode via a humidifier through an air supply line; a water trap that collects condensed water that is generated at the fuel electrode; a drain valve that is installed within a drain line between the water trap and the humidifier so that condensed water may be drained to the humidifier when the drain valve is open while the fuel cell system is operating; and a purge valve that is installed within a purge line that is branched from the drain line between the fuel cell stack and the water trap so that the condensed water and unreacted hydrogen may be exhausted to the humidifier when the purge valve is open while the fuel cell system is operating. In particular, when operation is terminated, by opening the drain valve, condensed water and unreacted hydrogen are exhausted to the humidifier. Finally, by opening the purge valve, unreacted hydrogen is purged to the air electrode inlet side.

Additionally, air from the air electrode may be exhausted to the humidifier through the air exhaust line, and the purge line may be connected to the air exhaust line and the air supply line. The purge valve may be installed at an intersection between the purge line and the air exhaust line. In doing so, the purge line, the air exhaust line, the air supply line, and an inlet may be connected.

As such, the purge valve may exhaust unreacted hydrogen to the humidifier by opening the air exhaust line side during operation and fill unreacted hydrogen at the air electrode inlet side by opening the air supply line side when operation is terminated.

The drain valve may be controlled to exhaust condensed water to the humidifier through the drain line, to exhaust unreacted hydrogen to the outside of a hollow fiber membrane module within the humidifier and into inject the unreacted hydrogen to the air electrode through the air supply line when operation is terminated.

Another embodiment of the present invention provides a method of purging a fuel cell system, the method including: including, by a fuel cell stack, a fuel electrode and an air electrode, injecting air of an air blower to the air electrode via a humidifier through an air supply line, collecting, by a water trap, condensed water that is generated at the fuel electrode, connecting the stack, the water trap, and the humidifier to a drain line having a drain valve, and branching a purge line from a drain line between the stack and the water trap and installing a purge valve at the purge line, exhausting condensed water and unreacted hydrogen to the humidifier by opening the drain valve and the purge valve, respectively, while operating, and exhausting condensed water and unreacted hydrogen to the humidifier by opening the drain valve and purging unreacted hydrogen to the inlet side of the air electrode by opening the purge valve, when operation is terminated.

In another exemplary embodiment of the present invention, a method for purging a fuel cell stack is provided. Specifically, during operation of the fuel stack, condensed water and unreacted hydrogen are exhausted to the humidifier by opening both a drain valve and a purge valve. When operation of the fuel cell stack is terminated, condensed water and unreacted hydrogen are exhausted to the humidifier by opening the drain valve, and then unreacted hydrogen is filled into the air electrode inlet side by opening the purge valve.

According to an exemplary embodiment of the present invention, unreacted hydrogen that is exhausted by fuel electrode purge is filled into an air electrode by recycling, and thus an OCV reduction speed can be improved. Additionally, durability performance of a fuel cell stack can be improved, and an operation termination time can be shortened. Finally, fuel consumption can be indirectly improved.

### BRIEF DESCRIPTION OF THE DRAWINGS

FIG. 1 is a schematic diagram of a conventional fuel cell system.

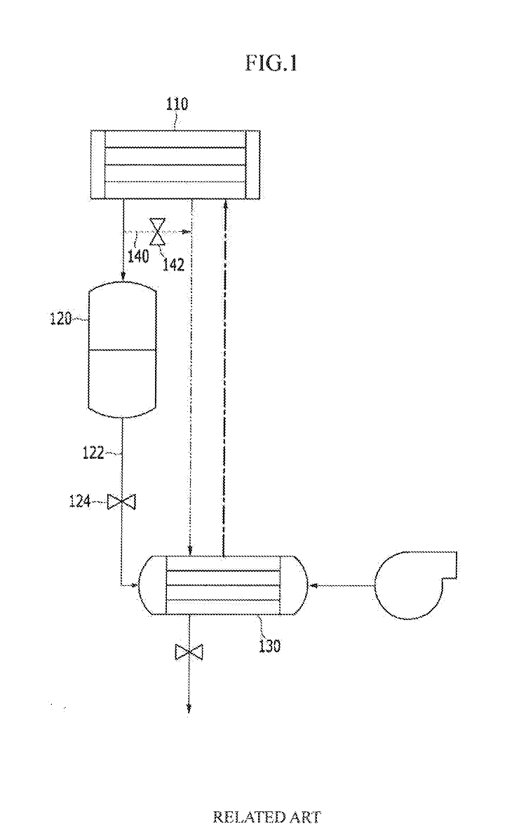

FIG. 2 is a schematic diagram of a fuel cell system according to an exemplary embodiment of the present invention.

FIG. 3 is a graph comparing OCV changes according to whether hydrogen purge of an air electrode is performed upon starting.

### DETAILED DESCRIPTION OF THE EMBODIMENTS

The present invention will be described more fully hereinafter with reference to the accompanying drawings.

Although exemplary embodiments of the present invention have been shown and described, it will be apparent to those having ordinary skill in the art that a number of changes, modifications, or alterations to the invention as described herein may be made, none of which depart from the spirit of the present invention.

The terminology used herein is for the purpose of describing particular embodiments only and is not intended to be limiting of the invention. As used herein, the singular forms “a”, an and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other katures, integers, steps, operations, elements, components, and/or groups thereof As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, fuel cell vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Additionally, it is understood that the below control logic and control methods are executed by at least one controller. The term controller refers to a hardware device that includes a memory and a processor and is thus a tangible structure defined by structurally by the control logic which it is configured to execute. The memory is configured to store the modules and the processor is specifically configured to execute said modules to perform one or more processes which are described further below.

Furthermore, the control logic of the present invention may be embodied as non-transitory computer readable media on a computer readable medium containi executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The features of the present invention will ow be described in detail below.

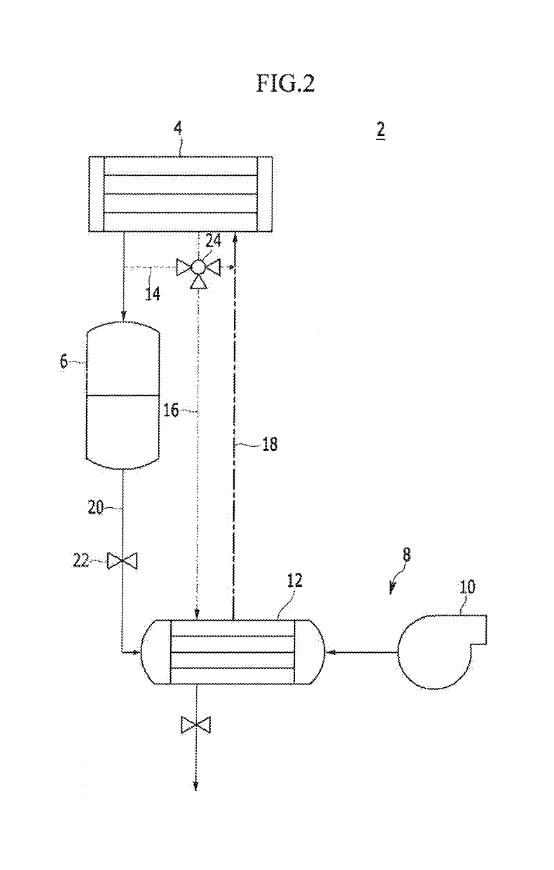

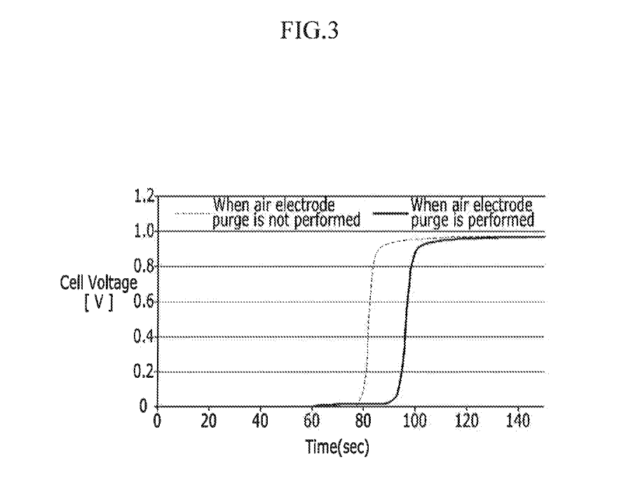

FIG. 2 is a schematic diagram of a fuel cell system according to an exemplary embodiment of the present invention, and FIG. 3 is a graph comparing OCV changes according to whether hydrogen purge of an air electrode is performed upon starting.

A fuel cell system 2 according to an exemplary embodiment of the present invention that is shown in FIG. 2 which includes a stack 4 that is formed with a set of unit cells, an air supply unit 8 that supplies air to the stack 4, a water trap 6 that collects condensed water that is generated at a fuel electrode, a drain valve 22 that is installed within a drain line 20 that connects the water trap 6 and a humidifier 12, and a purge valve 24 that is installed within a purge line 14 that is branched from the drain line 20 between the stack 4 and the humidifier 12.

The stack 4 of the fuel cell system is formed within an electricity generator set in which a plurality of unit cells are continuously arranged, and each unit cell is provided as a fuel cell of a unit that generates electrical energy by an electrochemical reaction of hydrogen and air.

Each unit cell includes a membrane-electrode assembly (MEA) and separators that are disposed in close contact with the MEA at both sides thereof. That is the separators are re conductive in nature and are typically shaped like a plate. The separator also includes channels, through which fuel and the oxidant flow along a surface in close contact with the membrane-electrode assembly, respectively.

The membrane-electrode assembly includes a fuel electrode (i.e., an anode) on one surface and forms an air electrode (i.e., cathode) on the other one surface. Additionally, an electrolyte membrane is disposed between the fuel electrode and the air electrode.

A fuel electrode separates fuel that is supplied through a channel within the separator into negatively charged electrons and positively charged protons through an oxidation reaction. The positively charged ions travel through the electrolyte to the cathode since the electrolyte membrane is specifically designed to allow only ions to pass therethrough. The negatively charged ions are then passed into an circuit to generate an electrical current.

The air supply unit 8 of the fuel cell system 2 includes an air compressor 10 and a humidifier 12. The air compressor 10 and the humidifier 12 are connected to the air electrode through an air supply line 18.

The humidifier 12 may be formed as a membrane humidifier in which a hollow fiber membrane module that is condensed with a plurality of hollow fiber membranes within a housing is disposed. Dry air that is injected into the humidifier 12 through the air supply line 18 moves toward the center of the hollow fiber membrane module. Humid air from the air electrode is exhausted toward the humidifier 12 through an air exhaust line 16 to move through the hollow fiber membrane module and exit therefrom. Condensed water that is generated at the fuel electrode is collected within the water trap 6 through the drain line 20 and is then exhausted to the humidifier 12 as well.

The drain valve 22 in the illustrative embodiment of the present invention is installed within the drain line 20 between the water trap 6 and the humidifier 12. At the drain line 20 of the water trap 6 and the fuel cell stack 4. The purge line 14 that exhausts unreacted hydrogen within the fuel electrode is branched therefrom as well.

More specifically, the purge line 14 is branched within the drain line 20 between the fuel cell stack 4 and the water trap 6 to be connected to the air exhaust line 16 and the air supply line 18. The purge valve 24 is installed within the purge line 14, and in an exemplary embodiment of the present invention, the purge valve 24 is installed within the purge line 14 that intersects the air exhaust line 16. The purge valve 24 may be embodied as a three-way valve in which the purge line 14, the air exhaust line 16, the air supply line 18, and an inlet are connected. Unreacted hydrogen within the fuel electrode is exhausted to the humidifier 12 through the air exhaust line 16 via the purge line 14 or is injected into the air electrode inlet side through the air supply line 18.

The drain valve 22 and the purge valve 24 are controlled to receive and generate an operation control signal for the fuel cell system 2. Specifically, while the fuel cell system 2 operates, the fuel cell system 2 exhausts condensed water and unreacted hydrogen to the humidifier 12 by opening the drain valve 22 and the purge valve 24. When the drain valve 22 is opened, condensed water that is collected within the water trap 6 is exhausted to the humidifier 12 through the drain line 20. In this case, when condensed water within the water trap 6 is filled to a predetermined water level, the drain valve 22 is controlled to automatically open.

The purge valve 24, on the other hand, exhausts unreacted hydrogen of the fuel electrode to the humidifier 12 by opening the air exhaust line 16 side. When operation is terminated, by opening the drain valve 22, condensed water and unreacted hydrogen are exhausted to the humidifier 12, and by opening the purge valve 24, unreacted hydrogen is filled into the air electrode inlet side. In this case, even when condensed water within the water trap 6 does not reach a predetermined water level, the drain valve 22 is opened, and at an upper area of condensed water within the water trap 6, unreacted hydrogen that is exhausted from the fuel electrode is supplied in this upper area. Therefore, when opening the drain valve 22, condensed water is first exhausted to the humidifier 12 and then unreacted hydrogen is exhausted to the humidifier 12.

Unreacted hydrogen that is exhausted to the humidifier 12 exits the hollow fiber membrane module and is injected into the air electrode through the air supply line 18. Further, by opening the air supply line 18 side of the purge valve 24, unreacted hydrogen is injected into the air electrode inlet side.

Hereinafter, a change of OCV according to whether hydrogen purge is performed at the air electrode will be described with reference to FIG. 3.

In a graph of FIG. 3, a horizontal axis represents a time (sec) and a vertical axis represents an OCV (V). A dotted line indicates a graph in which hydrogen purge is not performed with the air electrode, and a solid line indicates a graph in which hydrogen purge is performed with the air electrode.

As can be seen in FIG. 3, an OCV reduction speed in a graph in which hydrogen purge is performed with the air electrode is improved further than that in a graph in which hydrogen purge is not performed with the air electrode.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 2: fuel cell system | 4: stack |
| 6: watertrap | 8: air supply unit |
| 12: humidifier | 14: purge line |
| 16: air exhaust line | 18: air supply line |
| 20: drain line | 22: drain valve |
| 24: purge valve | |

What is claimed:

1. A fuel cell system, comprising:
a fuel cell stack that includes at least one fuel electrode and at least one air electrode;
an air supply unit that supplies air from a blower to the air electrode via a humidifier through an air supply line;
a water trap that collects condensed water that is generated within the fuel electrode;
a drain valve that is installed within a drain line between the water trap and the humidifier so that condensed water may be drained to the humidifier when the drain valve is open while the fuel cell system is operating; and
a purge valve that is installed within a purge line that is branched from the drain line between the fuel cell stack and the water trap so that the condensed water and unreacted hydrogen may be exhausted to the humidifier when the purge valve is open while the fuel cell system is operating,
wherein, when operation is terminated, the drain valve is opened so that the condensed water and the unreacted hydrogen are exhausted to the humidifier, and then the purge valve is opened in a different flow direction so that the unreacted hydrogen is purged and injected into the air electrode inlet side.

2. The fuel cell system of claim 1, wherein air from the air electrode is exhausted to the humidifier through the air exhaust line, and the purge line is connected to the air exhaust line and the air supply line.

3. The fuel cell system of claim 2, wherein the purge valve is installed where the purge line intersects the air exhaust line and is embodied as a three-way valve to which the purge line, the air exhaust line, the air supply line, and an inlet are directly connected.

4. The fuel cell system of claim 3, wherein the purge valve exhausts unreacted hydrogen to the humidifier by opening the air exhaust line side during operation and injecting unreacted hydrogen into the air electrode inlet side by opening the air supply line side when operation is terminated.

5. The fuel cell system of claim 2, wherein the drain valve controls exhaust of condensed water to the humidifier through the drain line, to exhaust unreacted hydrogen outside of a hollow fiber membrane module within the humidifier and to inject the unreacted hydrogen into the air electrode through the air supply line when fuel cell operation is terminated.

6. A method of purging a fuel cell system, the method comprising:
exhausting condensed water and unreacted hydrogen to a humidifier by opening a drain valve and a purge valve, respectively in the fuel cell system respectively during operation of the fuel cell; and
exhausting condensed water and unreacted hydrogen to the humidifier by opening the drain valve and then purging unreacted hydrogen toward the inlet side of the air electrode by changing a flow direction in the purge valve, when operation of the fuel cell system is terminated.

7. The method of claim 6, wherein air within an air electrode is exhausted to the humidifier through an air exhaust line, and a purge line is connected to the air exhaust line and an air supply line.

8. The method of claim 7, wherein the purge valve is installed where the purge line intersects the air exhaust line and is embodied as a three-way valve in which the purge line, the air exhaust line, the air supply line, and an inlet are connected.

9. The method of claim 8, wherein the purge valve exhausts unreacted hydrogen to the humidifier by opening the air exhaust line side while operating and inejecting unreacted hydrogen at the air electrode inlet side by opening the air supply line side when operation of the fuel cell system is terminated.

10. The method of claim 6, further comprising: exhausting, by the drain valve, condensed water to the humidifier through the drain line, exhausting unreacted hydrogen outside of a hollow fiber membrane module within the humidifier, and injecting the unreacted hydrogen into the air electrode through the air supply line, when operation is terminated.

11. The method of claim 6, wherein the method is executed in a fuel cell vehicle.
